(19) United States
(12) Patent Application Publication
(10) Pub. No.: US 2015/0073908 A1
(43) Pub. Date: Mar. 12, 2015

(54) METHOD FOR BROADCASTING CONTENT ON A PLURALITY OF COMMUNICATION CHANNELS

(71) Applicant: Mikael Boecasse, Londres (GB)

(72) Inventor: Mikael Boecasse, Londres (GB)

(21) Appl. No.: 14/381,593

(22) PCT Filed: Feb. 27, 2013
(86) PCT No.: PCT/EP2013/053981

§ 371 Date: Aug. 27, 2014

(30) Foreign Application Priority Data
Feb. 29, 2012 (FR) 1251833

(51) Int. Cl. G06Q 30/02

(52) U.S. Cl. CPC G06Q 30/0261; G06Q 30/0267; G06Q 30/0277; G06Q 30/0264
USPC 705/14.58

(57) ABSTRACT

A system for broadcasting content is provided. A piece of dynamic and interactive advertising content is broadcasted on a plurality of communication channels. The broadcasting of the piece of content linked to the same advertiser on the communication channels are synchronized in a given time range and in a given geographical location.

### RELATED APPLICATIONS

This application is a §371 application from PCT/EP2013/053981 filed Feb. 27, 2013, which claims priority from French Patent Application No. 12 51833 filed Feb. 29, 2012, each of which is herein incorporated by reference in its entirety.

### FIELD OF THE INVENTION

The present invention relates to the field of methods and systems for broadcasting content.

The present invention more particularly relates to a method for broadcasting a dynamic and interactive piece of advertising content on a plurality of communication channels comprising a synchronization step.

### PRIOR ART

Advertising has acquired great importance in today's economy, in the measure that it enables the stimulation of product sales, which has strategic value for companies.

Currently, pieces of advertising content can be broadcast on various communication channels. Examples include print media, television, radio, digital or traditional displays, or the Internet channel.

Thus, a commercial company wishing to launch a new product, or else improve the sales of an existing product, may choose one or more of the above-mentioned channels to launch an advertising campaign.

A mobile telecommunications operator can for example launch a new type of contract by accompanying this launch with displays in the streets of a town or on public transport, and by leading a parallel campaign on the Internet channel.

However, no technical solution exists today for broadcasting a piece of advertising content on a plurality of communication channels in a synchronized manner.

### OBJECT AND SUMMARY OF THE INVENTION

The present invention intends to remedy the drawbacks of the prior art by proposing a method making it possible to broadcast a piece of advertising content on a plurality of communication channels in a synchronized manner.

For this purpose, the present invention concerns, in the most general sense of the term, a method for broadcasting content, characterized in that it comprises the following steps:

broadcasting a dynamic and interactive piece of advertising content on a plurality of communication channels; and

synchronizing with the aim of broadcasting a piece of advertising content linked to one and the same advertiser on said communication channels in a given time interval and at a given geographical location.

Thus, the method according to the present invention allows the real-time synchronization of the information channels to deliver a piece of advertising content at the same moment.

According to one embodiment, said communication channels comprise the Internet channel.

According to one embodiment, said communication channels comprise the television channel.

According to one embodiment, said communication channels comprise the radio broadcasting channel.

According to one embodiment, said communication channels comprise print media.

According to one embodiment, said communication channels comprise the cinema.

According to one embodiment, said communication channels comprise outdoor displays.

According to a particular implementation, said communication channels comprise digital outdoor displays.

In a variant, said communication channels comprise a mobile telecommunications network.

Advantageously, said method furthermore includes a step of recognition of a user, following an action carried out by this user, by said advertiser following the broadcasting of said piece of advertising content.

In a variant, said time interval has a duration of half an hour.

In another variant, said time interval has a duration of one hour.

In another variant, said time interval has a variable duration.

Advantageously said method furthermore includes a step of exploiting data related to users for broadcasting the piece of content.

Preferably, said method furthermore includes a step of exploiting information linked to current events for broadcasting the piece of content.

The present invention also relates to a system for broadcasting content comprising at least one data server, characterized in that it comprises means for:

broadcasting a dynamic piece of advertising content on a plurality of communication channels; and

performing a synchronization with the aim of broadcasting a piece of advertising content linked to one and the same advertiser on said communication channels in a given time interval and at a given geographical location.

Advantageously, said system furthermore includes geolocation subsystem, e.g., a global positioning system (GPS), to obtain and store geolocation information related to users in a digital database.

Preferably, said system furthermore includes a digital database including data related to users.

According to one embodiment, said system furthermore includes a Decision-Making Artificial Intelligence sub-system.

### BRIEF DESCRIPTION OF THE DRAWINGS

The invention will be better understood using the description, given hereinbelow for purely explanatory purposes, of an embodiment of the invention, with reference to the figures wherein:

FIG. 1 represents the system according to the present invention in one embodiment;

FIG. 2 illustrates the system according to the present invention in one embodiment;

FIG. 3 represents an example of synchronization of advertising content on different channels;

FIG. 4 illustrates the various steps of the method according to the present invention;

FIG. 5 represents the system according to the present invention in one embodiment; and

FIG. 6 represents a server according to the present invention in one embodiment.

### DETAILED DESCRIPTION OF THE EMBODIMENTS OF THE INVENTION

The method according to the present invention allows the synchronization in real time of the information channels to deliver a piece of advertising content at the same moment.

The present invention relates to a method for broadcasting content, including the following steps:

broadcasting a dynamic and interactive piece of advertising content on a plurality of communication channels; and

synchronization with the aim of broadcasting a piece of advertising content linked to one and the same advertiser on said communication channels in a given time interval and at a given geographical location.

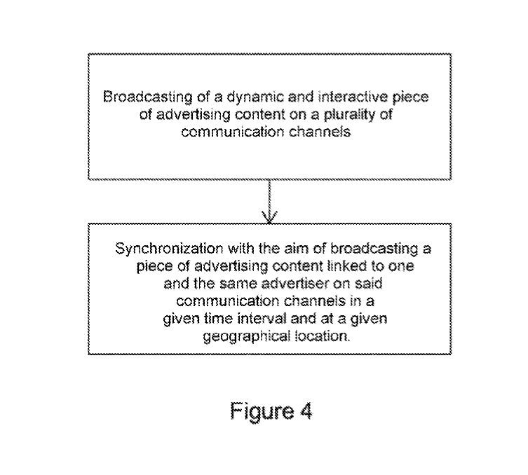

FIG. 4 illustrates the various steps of the method according to the present invention.

The various broadcasting channels are as follows:
Television;
Print media/Magazines;
Internet;
Mobile;
Cinema;
Digital and conventional displays; and
Radio.

The present invention allows a change in the way multimedia content, such as advertisement, is broadcasted on certain channels (Displays, Cinema, TV, Print media, Radio). Specifically, an advertisement will have a priority dependent on the price that the advertiser is prepared to pay; this can work as an auction system, for example.

On digital displays, the system according to the present invention uses an Internet connection (3G, optical, satellite, WiMAX).

On digital displays, the sending of multimedia files on digital displays is done by way of a peer-to-peer system, or ftp, or else http, or else streaming.

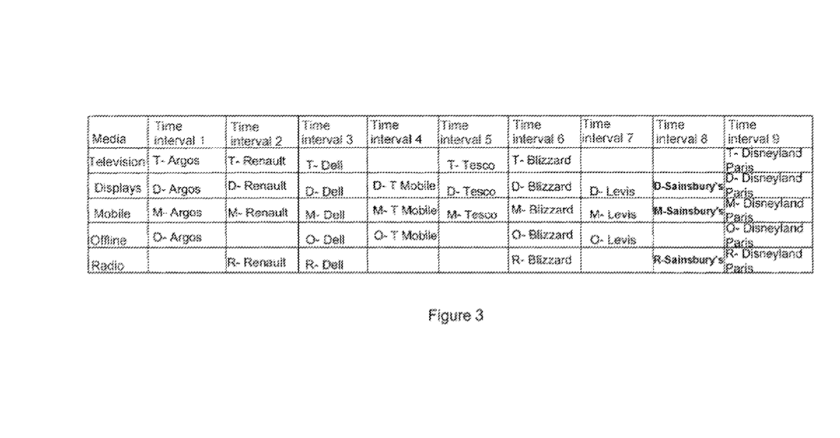

FIG. 3 represents an example of synchronization of multimedia content, e.g., advertising content, on different channels.

At an instant T, an advertisement can be broadcast on different communication channels at the same moment.

For example, with reference to FIG. 3, during the time interval 2, advertisements for RENAULT® cars are broadcast on a plurality of broadcasting channels: television, displays, mobile and radio. RENAULT® is a registered trademark of Renault.

In the same way, during the time interval 7, advertisements for LEVI'S® jeans are broadcast on a plurality of broadcasting channels: displays, mobile and offline. LEVI'S® is a registered trademark of Levi Strauss & Co.

During the time interval 9, advertisements for the DISNEYLAND® Paris theme park are also broadcast on a plurality of broadcasting channels: television, displays, mobile, offline and radio. DISNEYLAND® is a registered trademark of Walt Disney Productions Corporation.

Based on Decision-making Artificial Intelligence sub-system 310, the real-time server 300 and/or automated database management system 400 according to the present invention learns every day by drawing this information from the behavior of a web surfer and his or her environment.

The automated database management system 400 and/or the real-time server 300 according to the present invention extracts this information and stores in the database 405:
Sites visited by a web surfer;
Layout of the Internet connections;
The current economy of the country;
New burgeoning industries;
Sudden events that can change a way of life (natural disaster, discovery of a new natural resource).

This learning and analysis involves the Internet in the measure that it is the place where Information congregates (news, blogs, forums, scientific research sites etc.)

The consumers 800, i.e. the web surfers that have been found, will be placed in pools or segments 810 as a function of the collected information (tastes, type of purchase, behavior, time slot).

This grouping into pools 810 (segments 810) by the real-time server 300 and/or the automated database management system 400 makes it possible to increase targeting (conversions). This also makes it possible for the centralized multimedia server 200 to target specific segments (audiences).

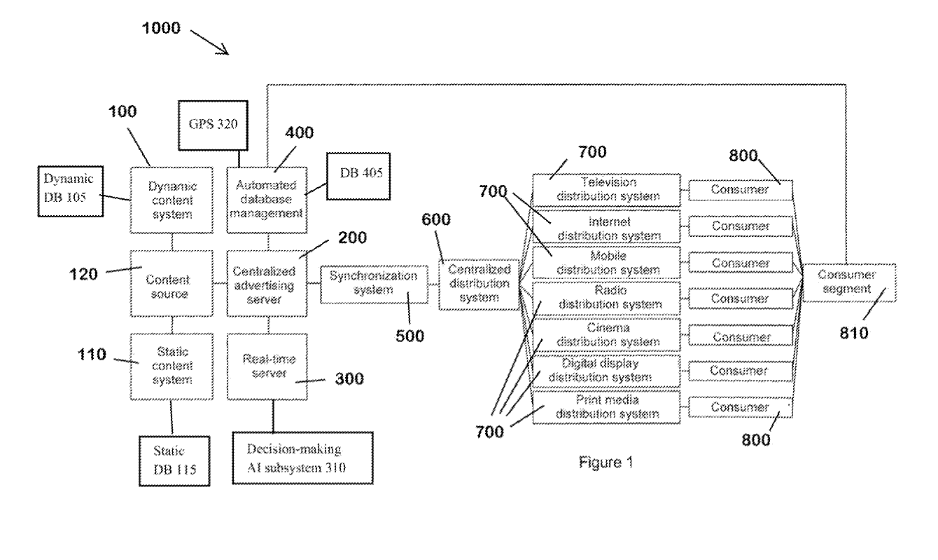

FIG. 1 represents the system 1000 according to the present invention in an embodiment. A dynamic content system 100 and a static content system 110, which house or stores various multimedia content in their respective databases 105, 115, are represented in FIG. 1. These two content systems 100, 110 interact with a centralized multimedia or advertising processor-based server 200, which is connected to a real-time server 300 and an automated digital database manager 400.

The centralized multimedia server 200, illustrated in FIG. 1, is connected to a synchronization system 500, itself connected to a centralized distribution system 600, which interacts with various distribution systems 700: the distribution system for television, the distribution system for the Internet channel, the distribution system for the “mobile” channel, the distribution system for radio etc. These different distribution systems 700 make it possible to distribute multimedia content, e.g., advertising content, to the consumer.

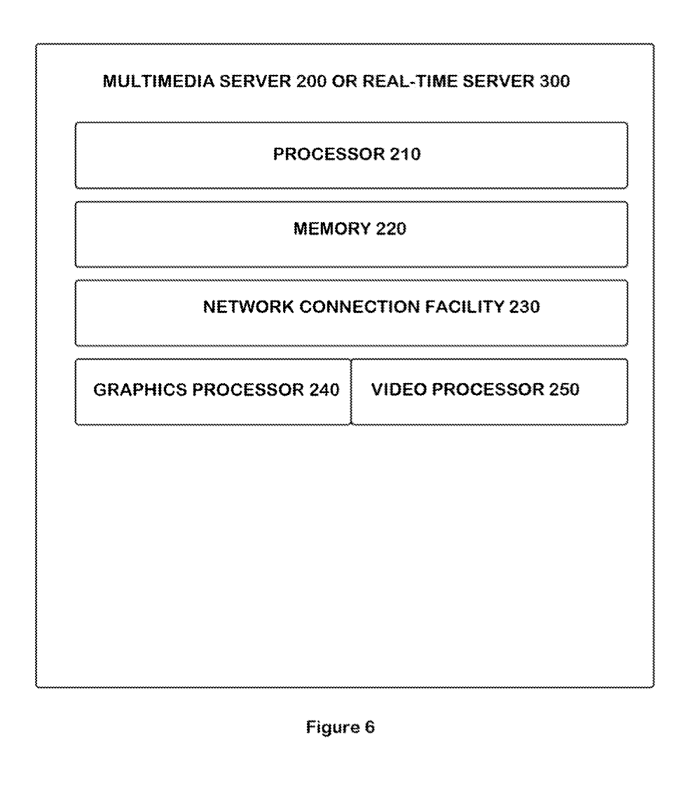

In accordance with an exemplary embodiment of the claimed invention, as shown in FIG. 6, the centralized multimedia or advertising server 200 and real-time server 300 comprises a server processor 210, a memory 220, a network connection facility 230 to connect/communicate with various components of the system as shown in FIG. 1, an optional graphics processor 240 to process multimedia content for distribution on the various distribution systems 700 and an optional video processor 250 to process multimedia content for distribution on the various distribution system 700.

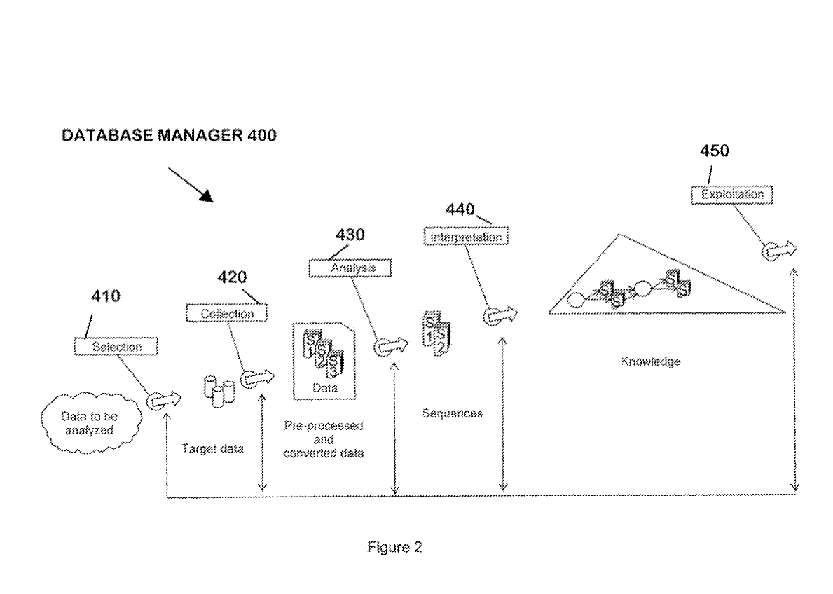

FIG. 2 illustrates the system 1000 in accordance with an exemplary embodiment of the claimed invention. This figure more specifically represents the automated digital database manager or automated analyzer 400. Data to be analyzed are selected from the database 405 by the automated digital database manager 400 to obtain the target data, at step 410. Then, the automated digital database manager 400 performs a collection phase to obtain pre-processed and converted data, which are stored in the database 405, at step 420. The server processor 210 of the real-time server 300 performs analysis on the data to obtain sequences, which are stored in the database 405 and/or temporarily stored in memory 220, at step 430. The server processor 210 of the real-time server 300 then interprets the analyzed data at step 440 to obtain so-called “knowledge” data that can be exploited by the system 1000 at step 450. That is, FIG. 2 indicates the operation of the automated analyzer 400 of consumer behavior. In accordance with an aspect of the claimed invention, the server processor 210 of the real-time server 300 can implement an approach of Fayyad et al. (1996), which represents the general process in the context of data resulting from the observation of consumer activity.

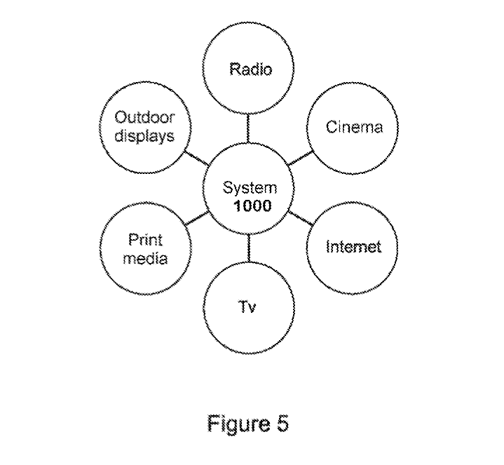

FIG. 5 represents the system 1000 in accordance with an exemplary embodiment of the claimed invention. As represented in this FIG. 5, the system 1000 according to the claimed invention broadcasts multimedia content on the different communication channels: radio, cinema, Internet, TV, print media and outdoor displays.

The system 1000 according to the present invention allows advertisers to have a “holistic/360° ” type of communication: a communication without borders that will bear the brand message on different communication channels. This will directly affect the audience, revenues and customer loyalty.

The system 1000 for broadcasting content according to the present invention comprises the centralized multimedia server 200, centralized distribution system 600, the synchronization system 500 and the automated digital database manager 400. The centralized distribution system 600 broadcasts a dynamic and interactive piece of multimedia content selected by the centralized multimedia server 200 on a plurality of communication channels 700. The synchronization system 500 synchronizes the broadcasting of the piece of multimedia content linked to one and same advertiser on the communication channels 700 in a predetermined time interval and at a given geographical location. The geolocation subsystem 320 (e.g., GPS 320) determines geolocations of users. The automated digital database manager 400 stores geolocations and data related to users in a digital database 405. The communication channels 700 comprise digital outdoor displays.

The centralized multimedia server 200 according to the present invention selects the piece of multimedia content to target a consumer segment. The centralized distribution system 600 broadcasts the selected piece of multimedia content on the communication channels 700.

The centralized multimedia server 200 according to the present invention selects the piece of multimedia content based on information linked to current events. The centralized distribution system 600 broadcasts the selected piece of multimedia content on the communication channels 700.

The system 1000 according to the present invention further comprises a Decision-Making Artificial Intelligence (Al) sub-system 320.

This “holistic” approach allows the globalization of communication campaigns.

The invention is described hereinabove by way of example. It is understood that those skilled in the art will be able to embody different variants of the invention without in any way departing from the scope of the patent.

1-16. (canceled)

17. A system for broadcasting content, comprising:
a centralized distribution system for broadcasting a dynamic and interactive piece of multimedia content selected by a centralized multimedia server on a plurality of communication channels;
a synchronization system for synchronizing the broadcasting of the piece of multimedia content linked to one and same advertiser on the communication channels in a predetermined time interval and at a given geographical location;
a geolocation subsystem for determining geolocations of users;
an automated digital database manager for storing geolocations and data related to users in a digital database; and
wherein the communication channels comprise digital outdoor displays.

18. The system as claimed in claim 17, wherein the communication channels comprise an Internet channel.

19. The system as claimed in claim 17, wherein the communication channels comprise a television channel.

20. The system as claimed in claim 17, wherein the communication channels comprise a radio broadcasting channel.

21. The system as claimed in claim 17, wherein the communication channels comprise print media.

22. The system as claimed in claim 17, wherein the communication channels comprise a cinema.

23. The system as claimed in claim 17, wherein the communication channels comprise outdoor displays.

24. The system as claimed in claim 17, wherein the communication channels comprise a mobile telecommunications network.

25. The system as claimed in claim 17, further comprising a real-time server for recognizing a user following an action carried out by the user after broadcast of the piece of multimedia content.

26. The system as claimed in claim 17, wherein a duration of the predetermined time interval is 30 minutes.

27. The system as claimed in claim 17, wherein a duration of the predetermined time interval is one hour.

28. The system as claimed in claim 17, wherein the predetermined time interval has a variable duration.

29. The system as claimed in claim 17, wherein the centralized multimedia server selects the piece of multimedia content to target a consumer segment; and wherein the centralized distribution system broadcasts the selected piece of multimedia content on the communication channels.

30. The system as claimed in claim 17, wherein the centralized multimedia server selects the piece of multimedia content based on information linked to current events; and
wherein the centralized distribution system broadcasts the selected piece of multimedia content on the communication channels.

31. The system as claimed in claim 17, further comprising a Decision-Making Artificial Intelligence sub-system.
